(19) United States
(12) Patent Application Publication
(10) Pub. No.: US 2022/0253462 A1
(43) Pub. Date: Aug. 11, 2022

(54) METHOD AND SYSTEM FOR CLASSIFYING COMPONENTS IN A PRODUCT DATA MANAGEMENT ENVIRONMENT

(71) Applicant: Siemens Industry Software Inc., Plano, TX (US)

(72) Inventors: Krishna Mohan Rao Nadimetla, Mason, OH (US); Abhijit Aklujkar, Pune (IN); Sandip Patil, Cincinnati, OH (US)

(21) Appl. No.: 17/618,432

(22) PCT Filed: Dec. 23, 2019
(86) PCT No.: PCT/US2019/068335

§ 371 Date: Dec. 10, 2021

(30) Foreign Application Priority Data
Jun. 12, 2019 (IN) 2019 31023336

(51) Int. Cl. G06F 16/28; G06Q 10/06

(52) U.S. Cl. CPC G06F 16/285; G06Q 10/06315

(57) ABSTRACT

A method and system for classifying components in a product data management (PDM) environment is disclosed. A method includes obtaining data files having information associated with a component to be classified in a PDM database. Each data file includes different types of information associated with the component. A series of predictions indicating a probability of the component belonging to one or more categories is computed based on each type of information associated with the component using one or more artificial intelligence models. An overall probability of the component belonging to the one or more categories is computed based on each of the series of predictions. The component is classified in at least one category of the one or more categories based on the computed probability of the component belonging to the one or more categories. The category associated with the classified component is output on a graphical user interface.

This application is the National Stage of International Application No. PCT/US2019/068335, filed Dec. 23, 2019, which claims the benefit of Indian Patent Application No. IN 201931023336, filed Jun. 12, 2019. The entire contents of these document are hereby incorporated herein by reference.

### FIELD OF THE TECHNOLOGY

The present disclosure generally relates to the field of product data management (PDM) and, more particularly, to a method and system for classifying components in a PDM environment.

### BACKGROUND

In today's highly responsive global markets, high value product innovations are quickly replicated by agile and aggressive global players. Manufacturers in every industry focus on increasing rate of innovation. Yet, many companies struggle to apply the resources needed to meet this challenge, because the companies waste resources on duplication of effort at every stage of product lifecycle. To overcome this limitation, companies are to get the most out of every component and process across a product portfolio. Benefits in terms of time to market and cost benefit analysis by pruning inventory may be much greater if high reuse culture is instilled in the organization. Precise classification of components in an enterprise is to be provided for promoting reuse. However, key barriers to achieving precise classification of components is high cost of classifying parts using a manual process.

### SUMMARY

A method and system for classifying components in a product data management (PDM) system is disclosed. In one aspect, a method includes obtaining one or more data files having information associated with at least one component to be classified in a PDM database. Each data file includes different types of information associated with the component. For example, the data files include text data associated with the component, image data associated with the component, or shape data associated with the component. The method includes computing a series of predictions indicating a probability of the component belonging to one or more categories based on each type of information associated with the component using one or more artificial intelligence models. The method includes computing overall probability of the component belonging to the one or more categories based on each of the series of predictions, and classifying the component in at least one category based on the computed probability of the component belonging to the one or more categories. The method may include outputting the category associated with the classified component on a graphical user interface.

In one embodiment, the method may include predicting a probability of the component belonging to one or more categories based on the text data associated with the component using a text classifier. In another embodiment, the method may include predicting a probability of the component belonging to one or more categories based on the image data associated with the component using an image classifier. In yet another embodiment, the method may include predicting a probability of the component belonging to one or more categories based on the shape data associated with the component using a shape indexer.

The method may include computing the overall probability of the component belonging to the one or more categories based on the series of predictions using a closed-loop weighted model. Further, the method may include identifying a category with highest probability from the one or more categories to which the component belongs, and classifying the component as belonging to the identified category in the PDM database.

The method may include storing metadata associated with the component in the PDM database. The metadata includes information associated with the category corresponding to the component and a unique identifier associated with the component.

The method may include receiving a query to retrieve one or more components in a specified category from the PDM database. The method may include retrieving information associated with at least one component corresponding to the specified category based on metadata associated with the specified category, and displaying the information associated with the at least one component corresponding to the specified category on a display unit.

In another aspect, a data processing system includes one or more processing units, and a memory unit communicatively coupled to the one or more processing units. The memory unit includes a component classification module stored in the form of machine-readable instructions and executable by the one or more processing units. The component classification module is configured to obtain one or more data files having information associated with at least one component to be classified in a PDM database. Each data file includes different types of information associated with the component. The component classification module is configured to compute a series of predictions indicating a probability of the component belonging to one or more categories based on each type of information associated with the component using one or more artificial intelligence models. Further, the component classification module is configured to compute overall probability of the component belonging to the one or more categories based on the series of predictions. The component classification module is configured to classify the component in at least one category based on the computed probability of the component belonging to the one or more categories.

The component classification module may be configured to output the category associated with the classified component on a display unit.

The component classification module may be configured to compute an overall probability of the component belonging to the one or more categories based on the series of predictions using a closed-loop weighted model.

The component classification module is configured to identify a category with highest probability from the one or more categories to which the component belongs, and classify the component as belonging to the identified category in the PDM database.

The component classification module may be configured to store metadata associated with the component in the PDM database. The metadata includes information associated with the category corresponding to the component and a unique identifier associated with the component.

The component classification module may be configured to receive a query to retrieve one or more components in a specified category from the PDM database, retrieve information associated with at least one component corresponding to the category based on metadata associated with the category, and display the information associated with the at least one component corresponding to the category on a display unit.

In yet another aspect, a non-transitory computer-readable storage medium stores instructions stored therein that, when executed by a data processing system, cause the data processing system to classify components in a product data management (PDM) environment. The instructions include obtaining one or more data files having information associated with at least one component to be classified in a PDM database. Each data file includes different types of information associated with the component. Further, the instructions includes computing a series of predictions indicating a probability of the component belonging to one or more categories based on each type of information associated with the component using one or more artificial intelligence models.

The instructions further include computing overall probability of the component belonging to the one or more categories based on the series of predictions, and classifying the component in at least one category based on the computed probability of the component belonging to the one or more categories.

The instructions may include outputting the category associated with the classified component on a display unit.

The instructions may include storing metadata associated with the component in the PDM database. The metadata includes information associated with the category corresponding to the component and a unique identifier associated with the component.

The instructions may include receiving a query to retrieve one or more components in a specified category from the PDM database, retrieving information associated with at least one component corresponding to the category based on metadata associated with the category, and displaying the information associated with the at least one component corresponding to the category on a display unit.

This summary is provided to introduce a selection of concepts that are further described below in the following description in a simplified form. The summary is not intended to identify features or essential features of the claimed subject matter. Further, the claimed subject matter is not limited to implementations that solve any or all disadvantages noted in any part of this disclosure.

### BRIEF DESCRIPTION OF THE DRAWINGS

FIG. 1 illustrates a block diagram of a data processing system in which an embodiment may be implemented as a product data management (PDM) system;

FIG. 2 illustrates a block diagram of a component classification system such as those shown in FIG. 1, according to one embodiment;

FIG. 3 is a process flowchart illustrating an exemplary method of classifying components in a PDM environment, according to one embodiment;

FIG. 4 is a process flowchart illustrating an exemplary method of providing component information based on a classification associated with the component, according to one embodiment;

FIG. 5 illustrates a block diagram of a data processing system in which an embodiment may be implemented; and

FIG. 6 is a diagrammatic representation depicting a process of classification of a component into a specific category using composite artificial intelligence models, according to one embodiment.

### DETAILED DESCRIPTION

A method and system for classifying components in a Product Data Management (PDM) system is disclosed. Various embodiments are described with reference to the drawings, where like reference numerals are used to refer to like elements throughout. In the following description, numerous specific details are set forth in order to provide thorough understanding of embodiments of the present disclosure. It will be apparent to one skilled in the art that these specific details need not be employed to practice embodiments of the present disclosure. In other instances, well known materials or methods have not been described in detail in order to avoid unnecessarily obscuring embodiments of the present disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the present disclosure.

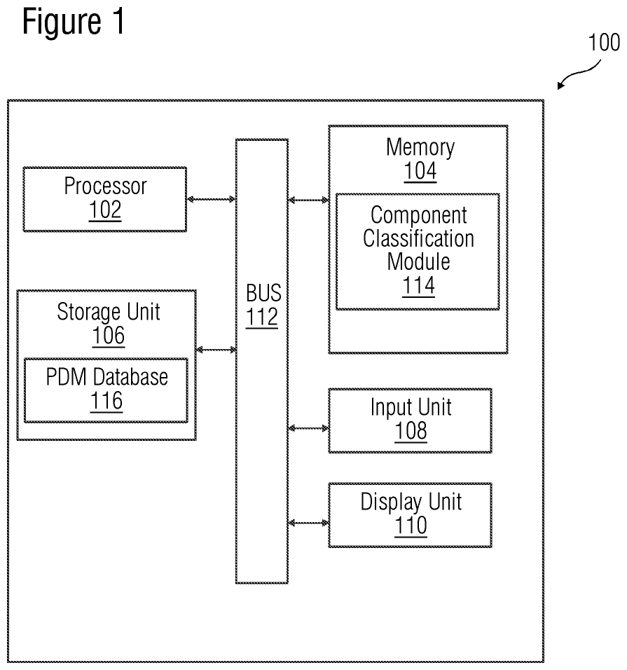

FIG. 1 illustrates a block diagram of a data processing system 100 in which an embodiment may be implemented, for example, as a Product Data Management (PDM) system, particularly configured by software or otherwise to perform the processes as described herein. The data processing system 100 may be a personal computer, a laptop computer, a tablet, and the like. In FIG. 1, the data processing system 100 includes a processor 102, an accessible memory 104, a storage unit 106, an input unit 108, a display unit 110, and a bus 112.

The processor 102, as used herein, may be any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processor 102 may also include embedded controllers, such as generic or programmable logic devices or arrays, application specific integrated circuits, single-chip computers, and the like.

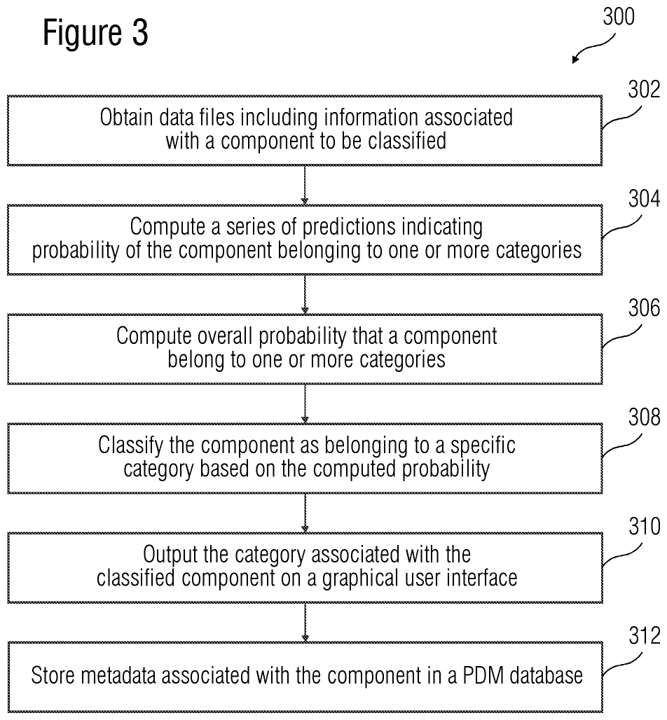

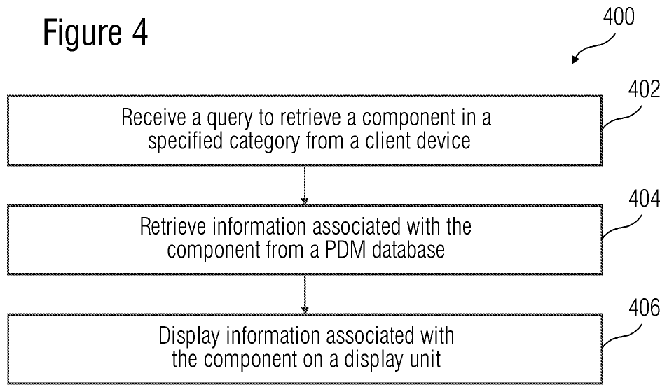

The memory 104 may be non-transitory volatile memory and non-volatile memory. The memory 104 may be coupled for communication with the processor 102, such as being a computer-readable storage medium. The processor 102 may execute instructions and/or code stored in the memory 104. A variety of computer-readable instructions may be stored in and accessed from the memory 104. The memory 104 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 104 includes a component classification module 114 stored in the form of machine-readable instructions on any of the above-mentioned storage media and may be in communication to and executed by the processor 102. When executed by the processor 102, the component classification module 114 causes the processor 102 to classify components in a PDM environment using machine learning algorithms. Method acts performed by the processor 102 to achieve the above functionality are described in greater detail in FIGS. 3 and 4.

The storage unit 106 may be a non-transitory storage medium that stores a PDM database 116. The PDM database 116 stores data files containing information associated with components to be classified. Each of the data files includes different types of information associated with the component. For example, different types of information include text data, image data, and/or shape data of components. The PDM database 116 also stores metadata associated with the classified components. The metadata includes information associated with the category corresponding to a component and unique identifier associated with a component. The input unit 108 may include input devices such as a keypad, a touch-sensitive display, a camera (e.g., a camera receiving gesture-based inputs), etc. capable of receiving input signals such as a data file including information associated with one or more components to be classified. The display unit 110 may be a device with a graphical user interface displaying a category associated with a component along with other information associated with the component. The graphical user interface may also enable users to input a search query for searching a component in the PDM database 116 based on a category. The bus 112 acts as interconnect between the processor 102, the memory 104, the storage unit 106, the input unit 108, and the display unit 110.

Those of ordinary skilled in the art will appreciate that the hardware depicted in FIG. 1 may vary for particular implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter may also be used in addition to or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed, and/or an event such as clicking a mouse button may be generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

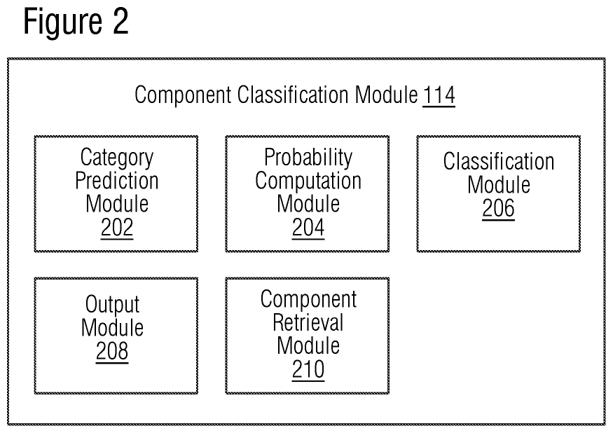

FIG. 2 illustrates a block diagram of the component classification system 114 such as those shown in FIG. 1, according to one embodiment. As shown in FIG. 2, the component classification system 114 includes a category prediction module 202, a probability computation module 204, a classification module 206, an output module 208, and a component retrieval module 210.

The category prediction module 202 is configured to compute a series of predictions indicating that a probability of a component belonging to one or more categories based on information associated with the component using artificial intelligence models. The probability computation module 204 is configured to compute overall probability of the component belonging to the different categories based on the series of predictions. The component classification module 204 is configured to classify a component into at least one of the categories based on the computed probability associated with the component. The output module 208 is configured to output a category in which the component is classified on the display unit 110. The component retrieval module 210 is configured to retrieve a requested component from the PDM database 116 based on the category associated with the component. The component retrieval module 210 is configured to display the requested component on the display unit 110.

FIG. 3 is a process flowchart 300 illustrating an exemplary method of classifying components in a PDM environment using machine learning model, according to one embodiment. At act 302, data files including information associated with a component to be classified are obtained from a PDM database 116. Each data file includes different types of information associated with the component. For example, each data file may include text data associated with the component (e.g., meta data of the component), image data associated with the component (e.g., two dimensional drawing), and/or shape data associated with the component (e.g., three dimensional picture of the component). The data file may be a computer-aided design files associated with the component stored in the PDM database 116.

At act 304, a series of predictions indicating that probability of the component belonging to one or more categories is computed based on each type of information associated with the component using one or more artificial intelligence models. In one embodiment, probability of the component belonging to one or more categories is predicted based on the text data (e.g., meta data) associated with the component using a text classifier. For example, the text classifier is based on a convolutional neural network (CNN) based artificial intelligence model. The text classifier may be trained using a training data set including meta data of different components. In another embodiment, probability of the component belonging to one or more categories is predicted based on the image data (e.g., two dimensional drawing) associated with the component using an image classifier. For example, the image classifier is based on TensorFlow algorithm. In yet another embodiment, probability of the component belonging to one or more categories is predicted based on the shape data (e.g., three dimensional image) associated with the component using a shape indexer. For example, the shape indexer is based on Geolus shape engine.

In one or more embodiments, the artificial intelligence models for computing the series of predictions are self-learning models. The artificial intelligence models make use of classification taxonomy data to predict probability of the component belonging to one or more categories according to a classification taxonomy.

At act 306, overall probability of the component belonging to the one or more categories is computed based on the series of predictions. In one exemplary implementation, the probability of the component belonging to the one or more categories is computed based on the series of predictions using a closed-loop weighted model. In one exemplary implementation, the closed loop weighted model computes the overall probability by combining the probability values corresponding to the specific category received from the text classifier, the image classifier, and/or the shape indexer. At act 308, the component is classified as belonging to at least one category based on the computed probability of the component belonging to the one or more categories. In one embodiment, a category with highest probability value is identified from the one or more categories to which the component belongs. The component is classified as belonging to the identified category in the PDM database 116. At act 310, the category associated with the classified component is output on a graphical user interface. At act 312, metadata associated with the component is stored in the PDM database 116. The metadata includes information associated with the category corresponding to the component and unique identifier associated with the component.

FIG. 4 is a process flowchart 400 illustrating an exemplary method of providing component information based on a classification associated with the component, according to one embodiment. At act 402, a query to retrieve one or more components in a specified category from the PDM database 116 is received from a client device. The query may include meta data associated with the component to be searched. At act 404, information associated with at least one component corresponding to the category is retrieved based on metadata associated with the component from the PDM database 116. At act 406, the information associated with the at least one component corresponding to the category is displayed on a display unit 110.

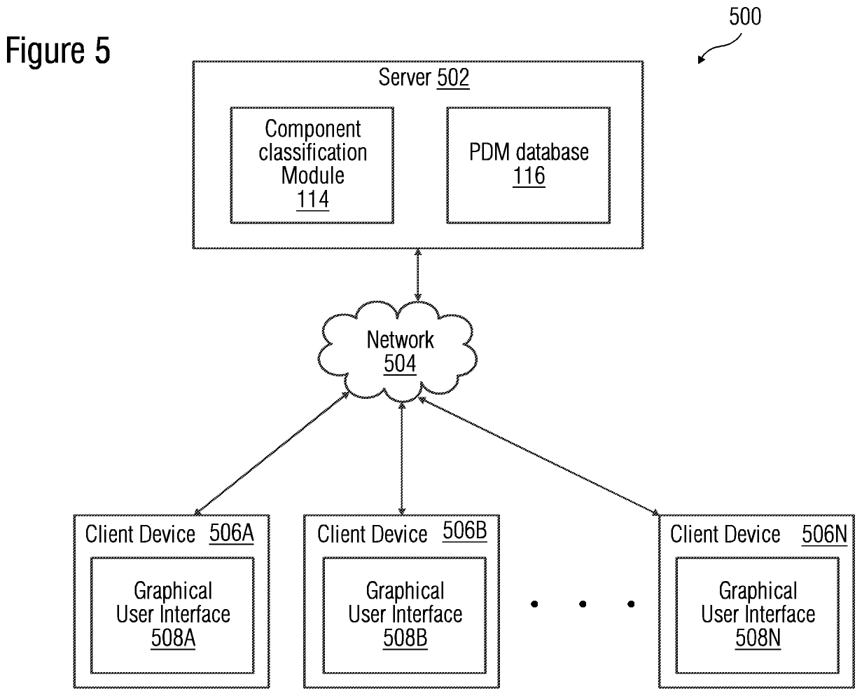

FIG. 5 illustrates a block diagram of a data processing system 500 in which an embodiment may be implemented. In one embodiment, the data processing system 500 includes a server 502 and a plurality of client devices 506A-N. Each client device of the plurality of client devices 506A-N is connected to the server 502 via a network 504 (e.g., Local Area Network (LAN), Wide Area Network (WAN), Wi-Fi, etc.). The data processing system 500 is another implementation of the data processing system 100 of FIG. 1, where the component classification module 114 resides in the server 502 and is accessed by the plurality of client devices 506A-N via the network 504.

The server 502 includes the component classification module 114 and the PDM database 116. The server 502 may also include a processor, a memory, and a storage unit. The component classification module 114 may be stored on the memory in the form of machine-readable instructions and executable by the processor. The PDM database 116 may be stored in the storage unit. The server 502 may also include a communication interface for enabling communication with the plurality of client devices 506A-N via the network 504.

When the machine-readable instructions are executed, the component classification module 114 causes the server 502 to compute a series of predictions indicating that a component belong to one or more categories using machine learning algorithms. Method acts performed by the server 502 to achieve the above-mentioned functionality are described in greater detail in FIGS. 3 to 5.

The plurality of client devices 506A-N include graphical user interfaces 508A-N, respectively, for managing information associated with the components such as category associated with the components. Each client device of the plurality of client devices 506A-N may be provided with a communication interface for interfacing with the server 502. Users of the plurality of client devices 506A-N may access the server 502 via the graphical user interfaces 508A-N. For example, the users may send request to the server 502 to classify the component under at least one category. Alternatively, the users may send request to the server 502 to retrieve a component belonging to a specific category. The graphical user interfaces 508A-N may be specifically configured for accessing the component classification module 114 in the server 502.

The component classification module 114 may reside in a cloud server in a cloud computing environment, where the plurality of client devices 506A-N connected via a cloud network may access the component classification module 114 to classify one or more components using machine learning algorithms.

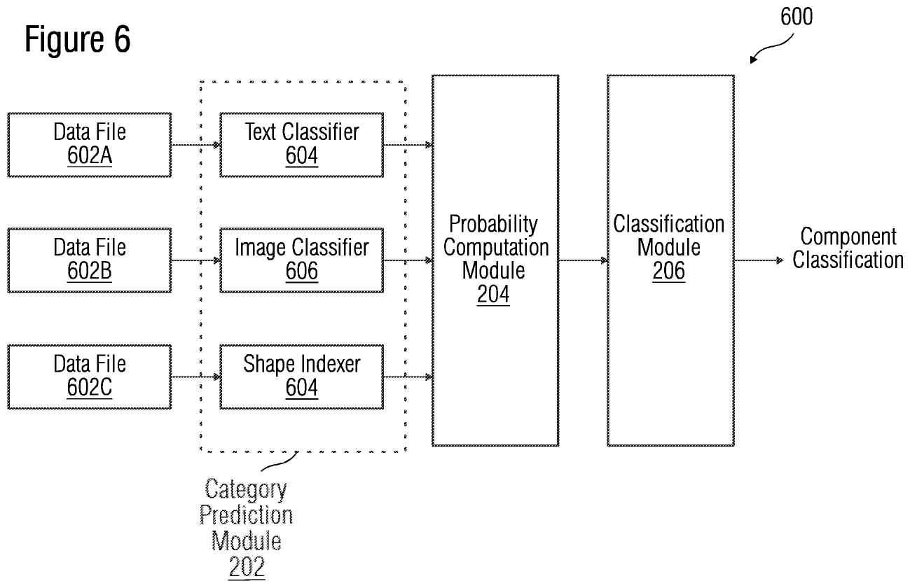

FIG. 6 is a diagrammatic representation 600 depicting classification of a component into a specific category using composite artificial intelligence models, according to one embodiment. As shown in FIG. 6, data files 602A-C consisting of meta data, image data, and shape data are input to the category prediction module 202, which includes a text classifier 604, an image classifier 606, and a shape indexer 608. The text classifier 603 may include a trained machine learning model (e.g., artificial neural network) capable of predicting probability of the component belonging to one or more categories based on text data (e.g., description, properties, etc.) associated with the component. The image classifier 606 may include a trained machine learning model (e.g., artificial neural network) capable of predicting probability of the component belonging to one or more categories based on image data (e.g., pixel data) associated with the component. The shape indexer 608 may include an index of shapes, derived from representative datasets of three-dimensional shapes, capable of predicting probability of the component belonging to one or more categories based on three-dimensional shape data associated with the component.

The text data file 602A may include meta data of the component such as unique identifier, name, type, owner, vendor, description, material, project and so on. The image data file 602B may include image associated with the component (e.g., engineering drawing). The shape data file 602C may include shape data of the component such as three-dimensional shape of the component.

Consider that meta data file 602A, image data file 602B, and shape data file 602C of a fastener bolt is input to the text classifier 604, the image classifier 606, and the shape classifier 608, respectively. The text classifier 604 computes a prediction indicating a probability of the component belonging to one or more categories by processing the text data file 602A. For example, the text classifier 604 computes the prediction indicating that there is 80% probability of being a bolt and 60% probability of being a stud. The image classifier 606 computes a prediction indicating a probability of the component belonging to one or more categories processing the image data file 602B. For example, the image classifier 606 computes the prediction indicating that there is 75% probability of being a bolt and 75% probability of being a stud. Similarly, the shape indexer 608 computes a prediction indicating a probability of the component belonging to one or more categories based on the shape data file 602C. For example, the shape indexer 608 computes the prediction indicating that there is 70% probability of being a bolt and 60% probability of being a stud.

The probability computation module 204 computes overall probability of the component belonging to one or more categories based on the predictions computed by the text classifier 604, the image classifier 606, and the shape indexer 608 using a closed loop weighted model. A closed loop weighted model is a trained machine learning model capable of computing overall probability of the component belonging to one or more categories based on the probability values from the text classifier 604, the image classifier 606, and/or the shape indexer 608.

In some embodiments, the probability computation module 204 computes probability of the fastener bolt belonging to ‘bolt’ category and ‘stud’ category by combining the predictions from the text classifier 604, and the image classifier 606. For example, the probability computation module 204 computes the probability of the fastener bolt falling a ‘bolt’ category and ‘stud’ category as follows:

Probability_{Bolt}: 0.80+0.70−(0.80×0.70)=95%

Probability_{Stud}: 0.60+0.75−(0.60×0.75)=90%

In these embodiments, the probability computation module 204 computes overall probability of the fastener bolt belonging to ‘bolt’ category and ‘stud’ category by combining the above probability with the prediction from the shape indexer 608. For example, the probability computation module 204 computes the overall probability of the fastener bolt falling in a ‘bolt’ category and a ‘stud’ category as follows:

Overall Probability_{Bolt}: 0.95+0.70−(0.95×0.70)=98.5%

Overall Probability_{Stud}: 0.90+0.6−(0.90×0.60)=96%

The classification module 206 identifies highest probability values from the plurality of probability values and classifies the component in a category with the highest probability value. Based on the overall probability, the classification module 206 classifies the fastener bolt under ‘bolt’ category as overall probability of the fastener bolt belonging to the ‘bolt’ category is 98.5%. The classification module 206 stores the classification metadata (e.g., category information) associated with the fastener bolt in the PDM database 116. In this manner, the component is classified in a specific category.

In the above example of classifying a fastener bolt, classification is performed based on known classification categories for similar images and shapes. In cases where classification categories are not known, the classification module 206 computes prediction indicating probability of the image belonging to a particular category. Similarly, the classification module 206 computes prediction indicating probability of the shape belonging to a particular category. This is achieved by multiplying the probability of image/shape similarity for unknown classification with the probability of the image/shape belonging to a particular category. The combined probability is used to determine the overall probability of the component belonging to a specific category in the manner as described above.

Those skilled in the art will recognize that, unless specifically indicated or required by the sequence of operations, certain acts in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system may conform to any of the various current implementations and practices known in the art.

It is to be understood that the system and methods described herein may be implemented in various forms of hardware, software, firmware, special purpose processors, or a combination thereof. One or more of the present embodiments may take a form of a computer program product including program modules accessible from computer-usable or computer-readable medium storing program code for use by or in connection with one or more computers, processors, or instruction execution system. For the purpose of this description, a computer-usable or computer-readable medium may be any apparatus that may contain, store, communicate, propagate, or transport the program for use by or in connection with the instruction execution system, apparatus, or device. The medium may be an electronic, magnetic, optical, electromagnetic, infrared, or semiconductor system (or apparatus or device); propagation mediums in and of themselves as signal carriers are not included in the definition of physical computer-readable medium. The medium may include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and/or a digital versatile disc (DVD). Both processors and program code for implementing each aspect of the technology may be centralized or distributed (or a combination thereof) as known to those skilled in the art.

While the present disclosure has been described in detail with reference to certain embodiments, it should be appreciated that the present disclosure is not limited to those embodiments. In view of the present disclosure, many modifications and variations would present themselves to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within their scope.

1. A computer-implemented method of classifying components in a product data management (PDM) system, the computer-implemented method comprising:
obtaining one or more data files comprising information associated with at least one component to be classified in a PDM database, wherein each data file of the one or more data files comprises different types of information associated with a component of the at least one component;
computing a series of predictions indicating a probability of the component belonging to one or more categories based on each type of information associated with the component using one or more artificial intelligence models;
computing a probability of the component belonging to the one or more categories based on the series of predictions; and
classifying the component in at least one category of the one or more categories based on the computed probability of the component belonging to the one or more categories.

2. The computer-implemented method of claim 1, further comprising:
outputting the at least one category associated with the classified component on a graphical user interface.

3. The computer-implemented method of claim 1, further comprising:
storing metadata associated with the component in the PDM database,
wherein the metadata comprises information associated with the category corresponding to the component and a unique identifier associated with the component.

4. The computer-implemented method of claim 1, wherein the one or more data files comprise text data associated with the component, image data associated with the component, shape data associated with the component, or any combination thereof.

5. The computer-implemented method of claim 4, wherein computing the series of predictions indicating that the component belongs to the one or more categories comprises:
predicting a probability of the component belonging to the one or more categories based on the text data associated with the component using a text classifier.

6. The computer-implemented method of claim 4, wherein computing the series of predictions indicating that the component belongs to the one or more categories comprises:
predicting a probability of the component belonging to the one or more categories based on the image data associated with the component using an image classifier.

7. The computer-implemented method of claim 4, wherein computing the series of predictions indicating that the component belongs to the one or more categories comprises:
predicting a probability of the component belonging to the one or more categories based on the shape data associated with the component using a shape indexer.

8. The computer-implemented method of claim 1, wherein computing the overall probability of the component belonging to the one or more categories based on the series of predictions comprises:
computing an overall probability of the component belonging to the one or more categories based on the series of predictions using a closed-loop weighted model.

9. The computer-implemented method of claim 1, wherein classifying the component in the PDM database based on the computed probability of the component belonging to the one or more categories, comprising:
identifying a category of the one or more categories with a highest probability from the one or more categories to which the component belongs to; and
classifying the component as belonging to the identified category in the PDM database.

10. The computer-implemented method of claim 1, further comprising:
receiving a query to retrieve one or more components in a specified category from the PDM database;
retrieving information associated with at least one component corresponding to the specified category based on metadata associated with the specified category; and
displaying the information associated with the at least one component corresponding to the specified category on a display unit.

11. A data processing system for classifying components in a product data management (PDM) environment, the data processing system comprising:
one or more processing units; and
a memory unit communicatively coupled to the one or more processing units, wherein the memory comprises a component classification module stored in the form of machine-readable instructions and executable by the one or more processing units, wherein the machine-readable instructions, when executed by the one or more processing units, are configured to:
obtain one or more data files comprising information associated with at least one component to be classified in a PDM database, wherein each data file of the one or more data files comprises different types of information associated with the component;
compute a series of predictions indicating a probability of a component of the at least one component belonging to one or more categories based on each type of information associated with the component using one or more artificial intelligence models;
compute overall probability of the component belonging to the one or more categories based on the series of predictions; and
classify the component in at least one category of the one or more categories based on the computed overall probability of the component belonging to the one or more categories.

12. The data processing system of claim 11, wherein the machine-readable instructions, when executed by the one or more processing units, are further configured to:
output the category associated with the classified component on a display unit.

13. The data processing system of claim 11, wherein the machine-readable instructions, when executed by the one or more processing units, are further configured to:
store metadata associated with the component in the PDM database,
wherein the metadata comprises information associated with the category corresponding to the component and a unique identifier associated with the component.

14. The data processing system of claim 11, wherein the computation of the overall probability of the component belonging to the one or more categories based on the series of predictions comprises:
computation of the overall probability of the component belonging to the one or more categories based on the series of predictions using a closed-loop weighted model.

15. The data processing system of claim 11, wherein the classification of the component in the PDM database based on the computed overall probability of the component belonging to the one or more categories comprises:
identification of a category with highest probability from the one or more categories to which the component belongs; and
classification of the component as belonging to the identified category in the PDM database.

16. The data processing system of claim 13, wherein the machine-readable instructions, when executed by the one or more processing units, are configured to:
receive a query to retrieve one or more components in a specified category from the PDM database;
retrieve information associated with at least one component corresponding to the specified category based on metadata associated with the specified category; and
display the information associated with the at least one component corresponding to the specified category on a display unit.

17. In a non-transitory computer-readable storage medium that stores instructions executable by a data processing system to classify components in a product management (PDM) environment, the instructions comprising:
obtaining one or more data files comprising information associated with at least one component to be classified in a PDM database, wherein each data file of the one or more data files comprises different types of information associated with a component of the at least one component;
computing a series of predictions indicating a probability of the component belonging to one or more categories based on each type of information associated with the component using one or more machine learning algorithms;
computing overall probability of the component belonging to the one or more categories based on the series of predictions; and
classifying the component in at least one category based on the computed probability of the component belonging to the one or more categories.

18. The non-transitory storage medium of claim 17, wherein the instructions further comprise:
outputting the category associated with the classified component on a display unit.

19. The non-transitory storage medium of claim 17, wherein the instructions further comprise:
storing metadata associated with the component in the PDM database, wherein the metadata comprises information associated with the category corresponding to the component and a unique identifier associated with the component.

20. The non-transitory storage medium of claim 19, wherein the instructions further comprise:
receiving a query to retrieve one or more components in a specified category from the PDM database;
retrieving information associated with at least one component corresponding to the specified category based on metadata associated with the specified category; and
displaying the information associated with the at least one component corresponding to the specified category on a display unit.
